(19) United States
(12) Patent Application Publication
(10) Pub. No.: US 2013/0192411 A1
(43) Pub. Date: Aug. 1, 2013

(54) HANDLEBAR ARRANGEMENT

(71) Applicant: Jon Wong, Long Beach, CA (US)

(72) Inventor: Jon Wong, Long Beach, CA (US)

(21) Appl. No.: 13/750,994

(22) Filed: Jan. 25, 2013

Related U.S. Application Data
(60) Provisional application No. 61/591,804, filed on Jan. 27, 2012.

(51) Int. Cl. B62K 21/12

(52) U.S. Cl. CPC B62K 21/12
USPC 74/551.9

(57) ABSTRACT

A handlebar arrangement for a bicycle or the like includes a handlebar having two opposing sides and adapted to turn a front wheel at a first pivot. Two tie rods are each pivotally attached at a forward end thereof proximate one of the ends of the handlebar at one of a pair of second pivots. Each tie rod terminates at a handle. In different embodiments, each handle is pivotally attached to the rearward end of one of the tie rods, or the handle of each tie rod includes a rotational bearing where connected to the tie rod, or each tie rod is pivoted to allow substantially 180 degrees of horizontal pivoting of the tie rod with the handlebar, and substantially 90 degrees of vertical upward pivoting of the tie rod with the handlebar, or each tie rod may be mutually pivotally connected with a connecting rod.

### CROSS-REFERENCE TO RELATED APPLICATIONS

This application claims the benefit of U.S. Provisional Patent Application 61/591,804, filed on Jan. 27, 2012, and incorporated herein by reference.

### STATEMENT REGARDING FEDERALLY SPONSORED RESEARCH AND DEVELOPMENT

Not Applicable.

### FIELD OF THE INVENTION

This invention relates to vehicles, and more particularly to an improved handlebar arrangement.

### BACKGROUND

Traditional bicycle handlebars, and similar handlebars for other velocipede-type vehicles, pivot around a first pivot of the vehicle to steer the front wheel thereof. As such, a rider typically must lean well forward in order to reach both sides of the handlebar as it pivots around the first pivot. This can be uncomfortable, particularly during extended rides.

Several prior art patents teach devices that aim to make such bicycle handlebars adjustable to accommodate different sized riders or to allow for more comfortable handlebar positioning. For example, U.S. Pat. No. 5,144,859 to Malone on Sep. 8, 1992, teaches a handlebar having rotating U-shaped ends that allow such ends to be rotationally adjusted about a longitudinal axis of the handlebars. Such a device, however, doesn't provide for moving the handlebars generally closer to the rider, resulting in the rider still having to lean generally forward while steering. If the U-shaped ends were enlarged, rotating could move the handlebars closer to the rider, but with only a single pivot about a vertical axis on the handlebars the handlebar swing radius is enlarged, causing the rider to swing outward further along with the center of gravity, which makes the rider both uncomfortable and off balance.

Just extending the handlebars rearwardly, as suggested by U.S. Pat. No. 379,955 to Hedger on Mar. 27, 1888, and as shown in U.S. Pat. No. 619,126 to Blashfield on Feb. 7, 1899, is a poor solution since the effective range of the steering with such a handle will be limited to the reach of the rider's arms along an arc defined by the length of the handlebars from the first pivot point. That is, the handlebar swing radius is enlarged. As such, the rotational range that a single rider may impart to the handlebar is reduced. Further, such handlebars if lengthened sufficiently impact the rider with only a small turn of the handlebars, restricting the rotational range of the handlebars and very possibly dangerously so.

U.S. Pat. No. 4,361,057 to Kochera on Nov. 30, 1982 teaches an adjustable handlebar that allows for discrete rotational positions of handlebar ends with respect to secondary pivots near the neck or center of the handlebar's first pivot point. Such a device does not allow the continuous rotational adjustment of the handlebar ends nor does it provide for much extension of the handlebars rearwardly towards the driver. Generally, prior art devices such as Kochera with adjustable handlebars teach the ends of the handlebars being vertically adjustable up and down, which does little to help a rider keep a more vertical position over the seat and center of gravity of the vehicle. This results in additional fatigue and discomfort.

Therefore, there is a need for a handlebar arrangement that allows the rider to sit-up straighter or even reclined rearwardly, without leaning forward and while still having full steering control of the vehicle. Such a needed invention would allow for a wide variety of adjustments and positions of the handles that ultimately steer the vehicle. Moreover, such a needed invention would be relatively inexpensive to manufacture and easy to use. The present invention accomplishes these objectives.

### SUMMARY OF THE INVENTION

The present device a handlebar arrangement for a vehicle of the type having at least one steerable front wheel pivotally fixed with a frame at a first pivot, such as a bicycle. The handlebar arrangement includes a handlebar, either linear or curved, that is adapted to turn the at least one front wheel at the first pivot. The handlebar has two opposing sides.

A pair of rigid metal or plastic tie rods are each pivotally attached at a forward end thereof proximate one of the sides of the handlebar at one of a pair of generally vertically-oriented second pivots. As such, the each tie rod may rotate with respect to the handlebar in a substantially horizontal plane. In one embodiment, each second pivot is selectively moveable along the handlebar with a slide lock mechanism.

Each tie rod terminates at a rearward end thereof at a handle. In one embodiment, each handle is pivotally attached to the rearward end of one of the tie rods at one of a pair of generally vertically-oriented third pivots, allowing the handle to pivot in the horizontal plane. In one embodiment, the handle of each tie rod includes a rotational bearing where connected to the tie rod, such that the handle is rotatable about an axis generally aligned with a longitudinal axis of the tie rod.

In another embodiment, each tie rod further includes a generally horizontally-oriented forth pivot proximate the forward end thereof. In one embodiment, the second pivot and forth pivot of each tie rod may be replaced with a ball pivot, allowing substantially 180 degrees of horizontal pivoting of the tie rod with the handlebar, and substantially 90 degrees of vertical upward pivoting of the tie rod with the handlebar. In one embodiment, each tie rod may be mutually pivotally connected with a connecting rod at a pair of fifth pivots proximate the rearward ends of the tie rods.

In use, pushing one of the tie rods forward or pulling the other tie rod backward results in turning of the handlebar and the at least one front wheel. In an embodiment that includes the connecting rod, the rider may steer the at least one front wheel by pushing or pulling opposing sides of the connecting rod.

The present invention is a handlebar arrangement that allows the rider to sit-up straight or even recline without leaning forward, all while maintaining full steering control of the vehicle. The present device allows for a wide variety of adjustments and positions of the handles that ultimately steer the vehicle's front wheel, as dictated by comfort of the rider. Moreover, the present device is relatively inexpensive to manufacture and easy to use. The connecting rod embodiments stabilize the handles and tie rods with respect to each other, and allows for one-handed steering of the vehicle. The multiple pivoting system of the present invention allows steering in a more fore and aft arm motion, allowing the rider to stay more centralized over the seat, more comfortable, and more stable.

Each handle can be operated at a different distance from the first pivot as desired by the rider. The present system allows for a decreased turn radius with the user being able to maintain a more centered position on the vehicle. Further, lengthening the distance between the first pivot and the handles allows for retention of a more vertically-oriented first pivot, which improves handling of the vehicle (unlike a more “chopper” style inclined first pivot which also moves the handlebars backwards more towards the user but results in degraded handling). The present device reduces a rider's stress and fatigue that prior art arrangements caused by requiring a substantially stationary holding position of the handle and a fixed, repetitious path of the hands and arms for steering. The multi-pivoting functions and movements mimic the human body (arms, joints, and tendons) and becomes in no small part a more natural, fluid, and intuitive extension of the user's body. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective view of the invention, illustrating a pair of tie rods pivotally fixed with opposing sides of a handlebar of a vehicle;

FIG. 2 is a perspective view of an alternate embodiment of the invention having pivoting handles at rearward ends of the tie rods;

FIG. 3 is a perspective view of an embodiment wherein the distance between the tie rods and a first pivot of the vehicle is adjustable;

FIG. 4 is a perspective view of an embodiment wherein the handles are each rotatably mounted to the rearward ends of the tie rods;

FIG. 5 is a perspective view of an embodiment wherein the length of the tie rods are selectively adjustable with a telescoping mechanism;

FIG. 6 is a perspective view of an embodiment with a curved handlebar;

FIG. 7 is a perspective view of an alternate curved handlebar;

FIG. 8 is a perspective view of an embodiment wherein the tie rods are each upwardly pivotable with respect to a horizontal plane;

FIG. 9 is a perspective view of an embodiment wherein each tie rod is connected with a connecting rod;

FIG. 10 is a perspective view of an embodiment having an alternate connecting rod;

FIG. 11 is a perspective view showing a drop stop associated with a forth pivot of the tie rods;

FIG. 12 is a perspective view of an embodiment having another alternate connecting rod;

FIG. 13 is a perspective view of an embodiment having yet another alternate connecting rod;

FIG. 14 is a perspective view of one embodiment showing a plurality of ball pivots;

FIG. 15 is a perspective view of an embodiment with springs as biasing means for the handles;

FIG. 16 is a perspective view of an embodiment having an alternate ball pivot; and

FIG. 17 is a perspective view of an embodiment having an alternate elastomeric tie rod that works similarly to the embodiment having the ball pivot.

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

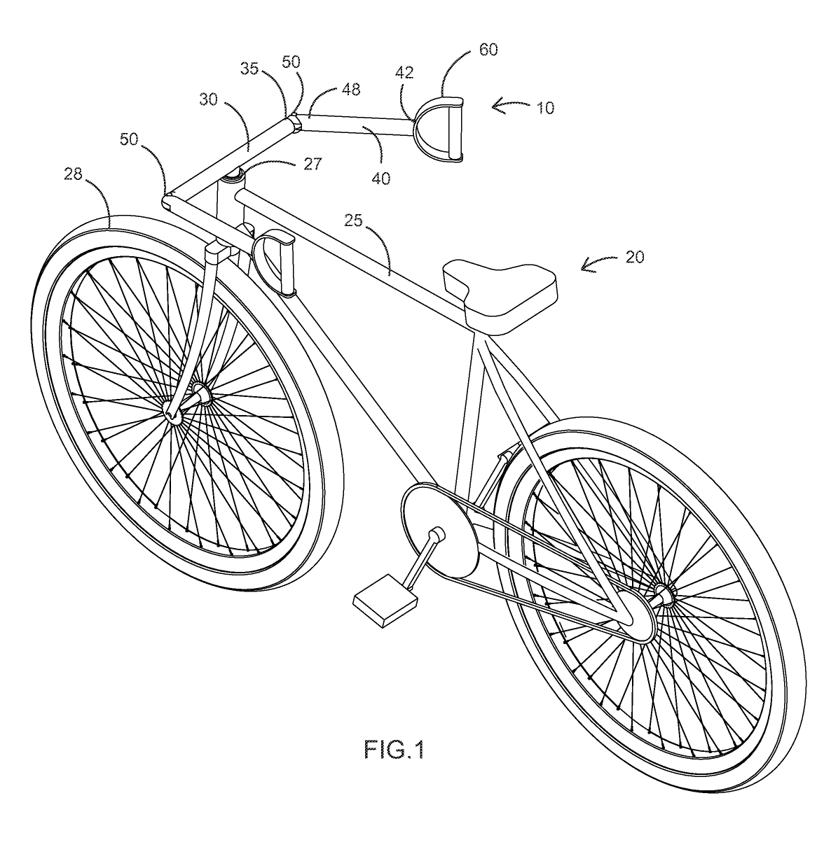

FIG. 1 illustrates a handlebar arrangement 10 for a vehicle 20 of the type having at least one steerable front wheel 28 pivotally fixed with a frame 25 at a first pivot 27. Such a vehicle 20 may be, for example, a bicycle, tricycle, so-called “trike” vehicle, so-called “quad” or other multi-wheeled vehicle, or the like.

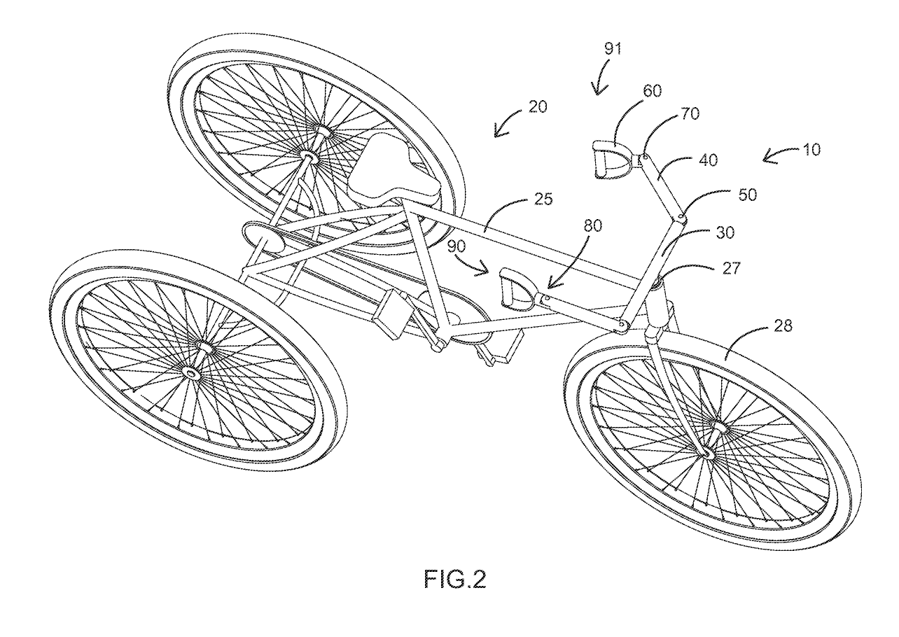

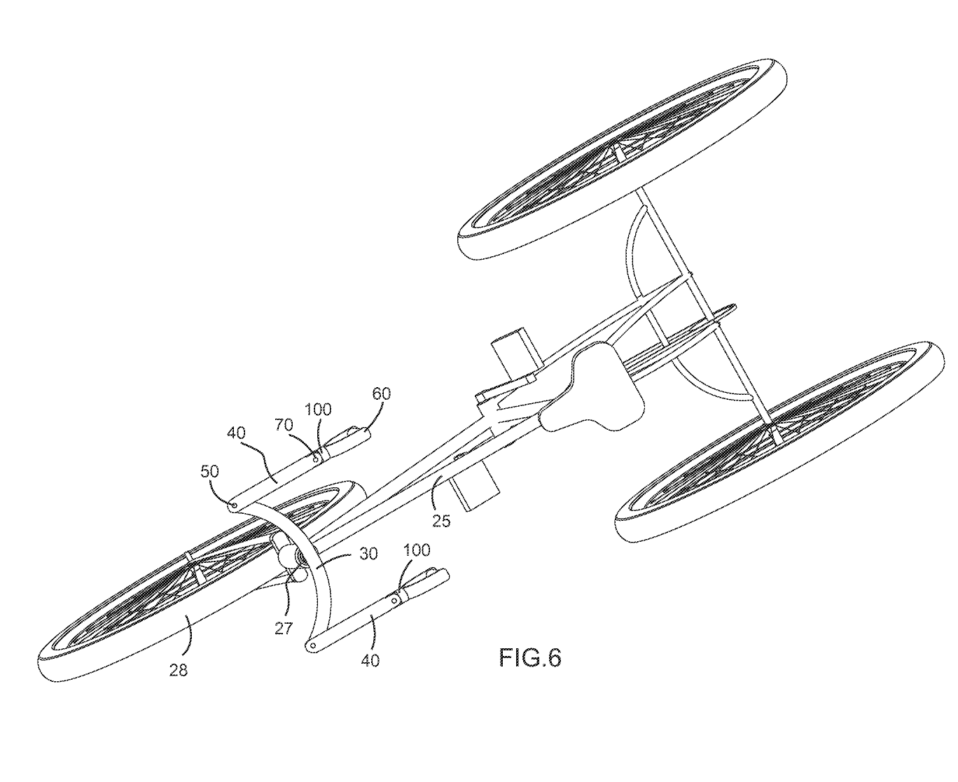

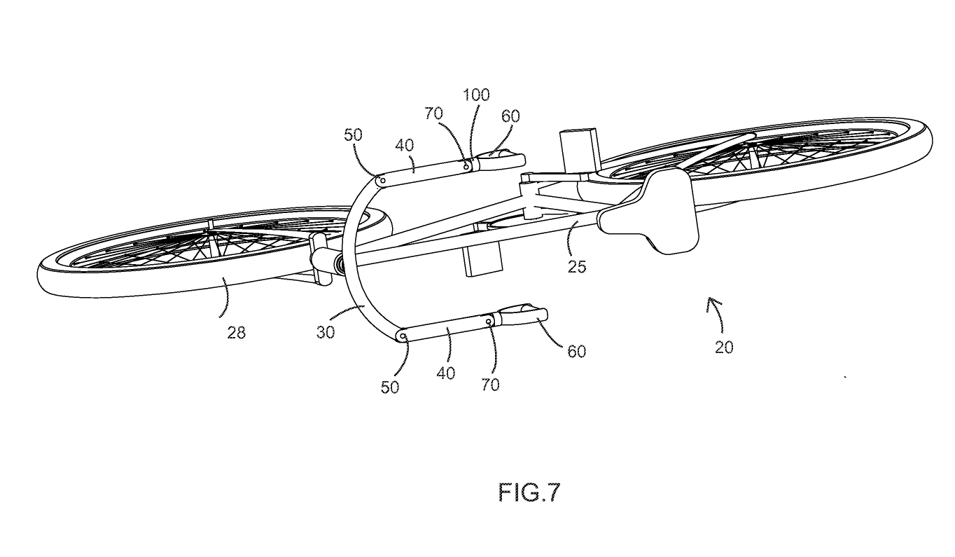

The handlebar arrangement 10 includes a handlebar 30, either linear or curved (FIGS. 2, 6 and 7), that is adapted to turn the at least one front wheel 28 at the first pivot 27. The handlebar 30 has two opposing sides 35 and is substantially rigid, being made from a suitable metal or rigid plastic material, or the like.

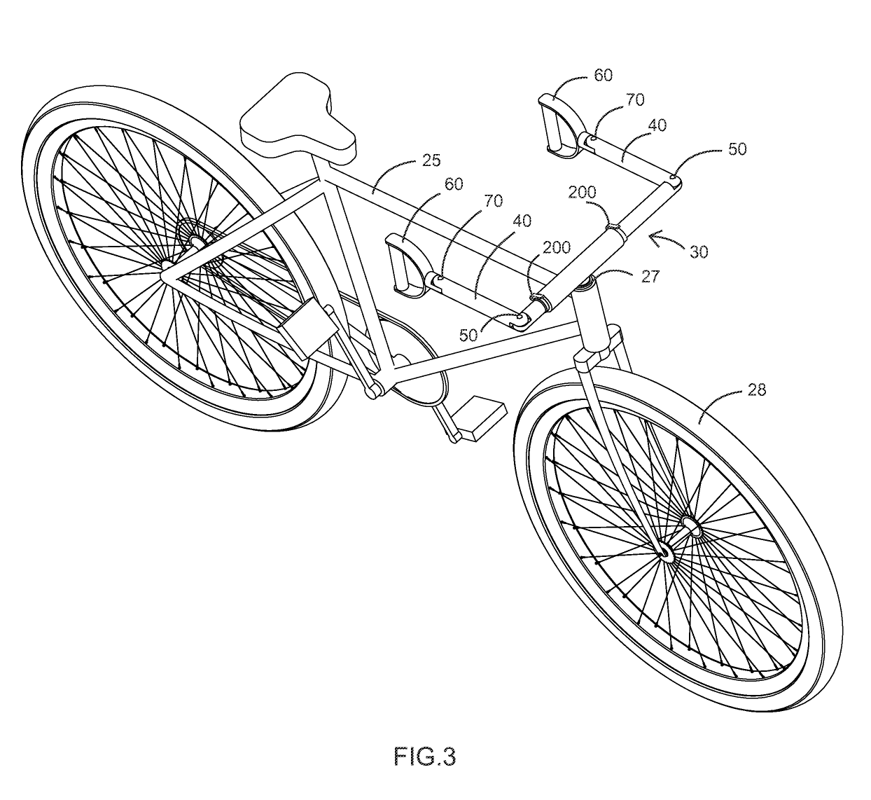

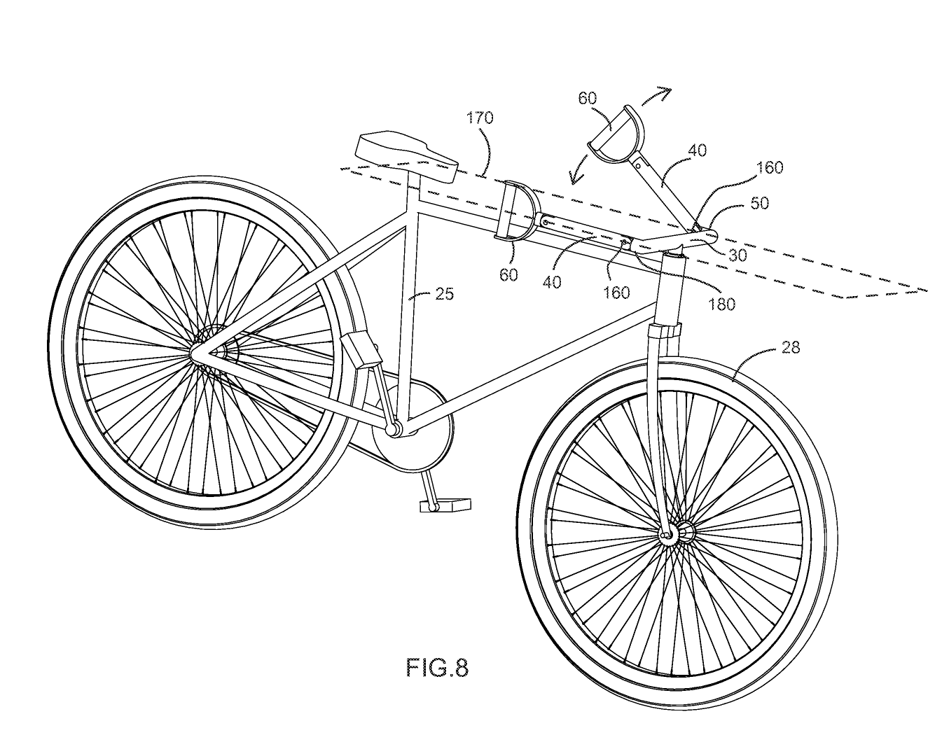

A pair of rigid metal or plastic tie rods 40 are each pivotally attached at a forward end 48 thereof proximate one of the sides 35 of the handlebar 30 at one of a pair of generally vertically-oriented second pivots 50. As such, the each tie rod 40 may rotate with respect to the handlebar 30 in a substantially horizontal plane 170 (FIG. 8). In one embodiment, each second pivot 50 is selectively moveable along the handlebar 30 with a slide lock mechanism 200 (FIG. 3), such that the torque required to turn the at least one front wheel 28 is selectively adjustable by positioning the second pivots 50 either closer to or further away from the first pivot 27. Such a slide lock mechanism 200 is preferably manually selectively adjustable, such as a locking telescoping mechanism, or the like.

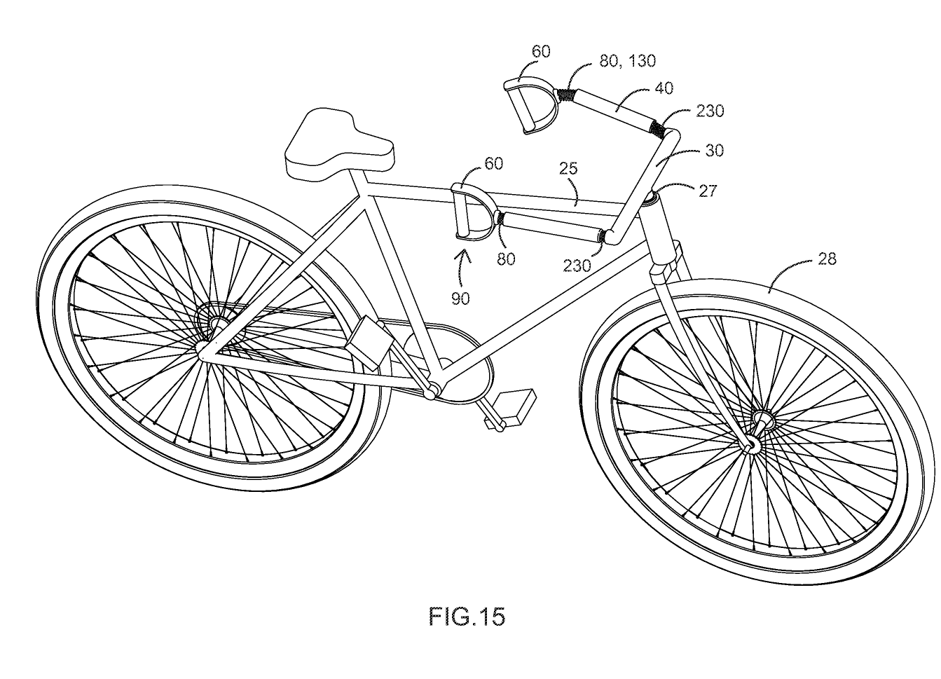

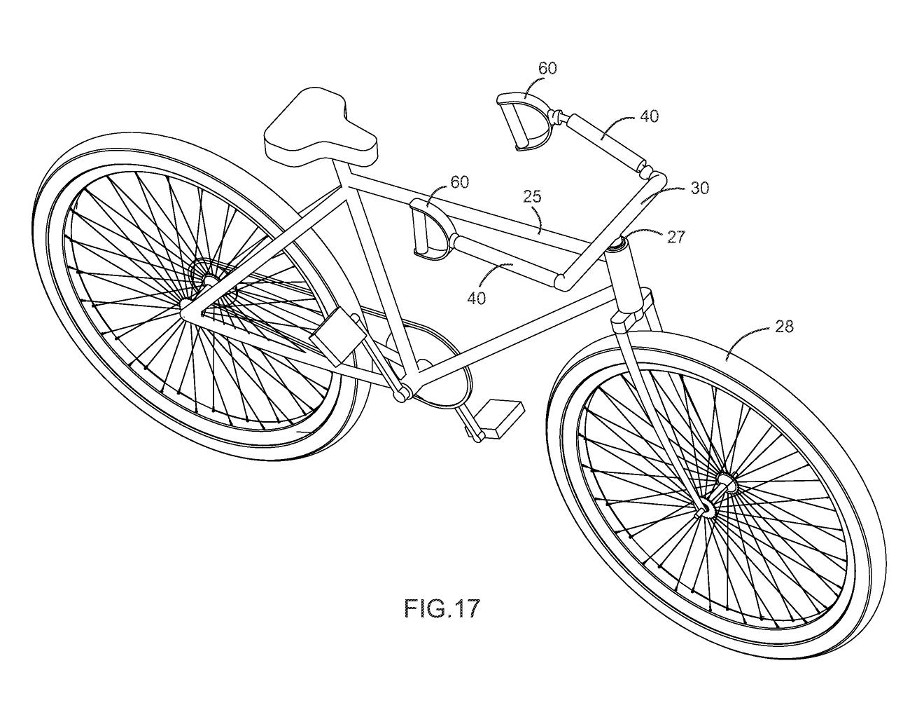

Each tie rod 40 terminates at a rearward end 42 thereof at a handle 60. In one embodiment, each handle 60 is pivotally attached to the rearward end 42 of one of the tie rods 40 at one of a pair of generally vertically-oriented third pivots 70, allowing the handle 60 to pivot in the horizontal plane 170. As such, a rider may keep the handles 60 oriented in substantially the same direction while still steering the vehicle 20 by pushing or pulling the handles 60. In one embodiment, each third pivot 70 further includes a biasing mechanism 80 (FIG. 15) to bias the handle 60 to return from a pivoted position 91 to a default pivotal position 90 (FIG. 2). Each handle 60 may include an ergonomic grip, and may take various shapes as desired, provided a user may comfortable grip such a handle 60. The biasing mechanism 80 may also be made from an elastomeric material (FIG. 17).

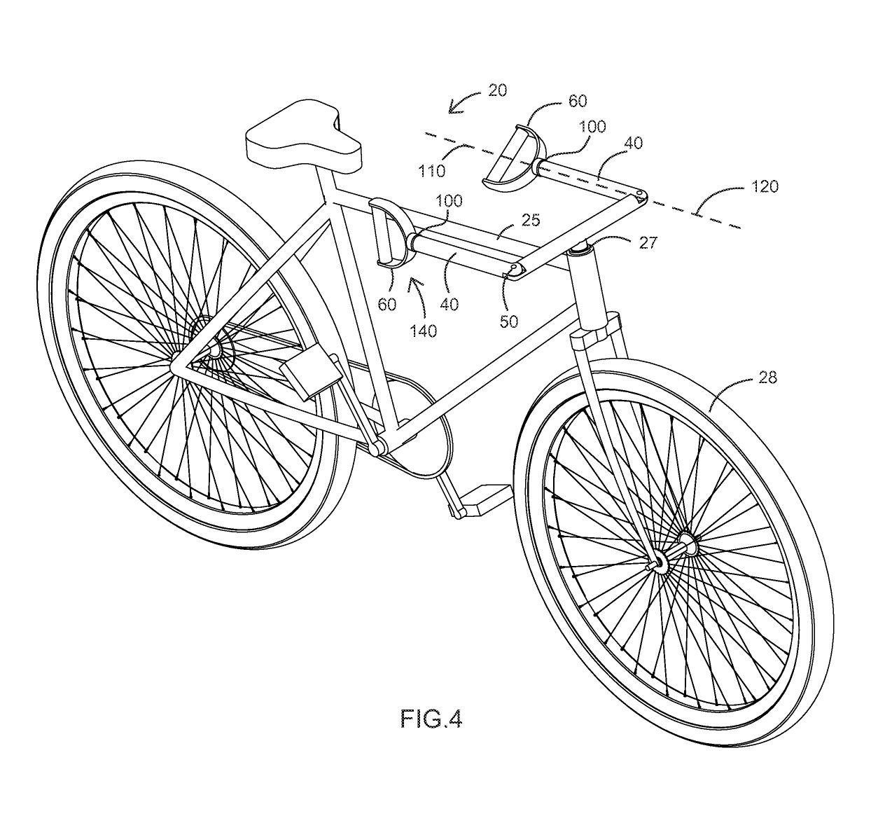

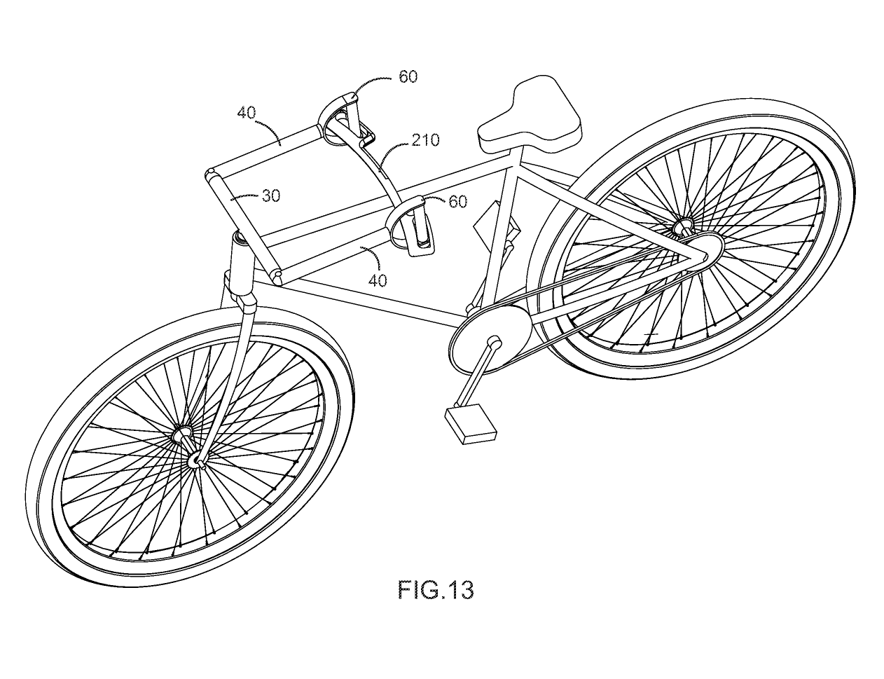

In one embodiment, the handle 60 of each tie rod 40 includes a rotational bearing 100 (FIG. 4) where connected to the tie rod 40, such that the handle 60 is rotatable about an axis 110 generally aligned with a longitudinal axis 120 of the tie rod 40. In such an embodiment, each handle 60 may include a second biasing mechanism 130 (FIG. 13), such as a coil spring arrangement, to bias the return of the handle 60 to a default rotational position 140. The second biasing mechanism 130 may also be made from an elastomeric material (FIG. 17).

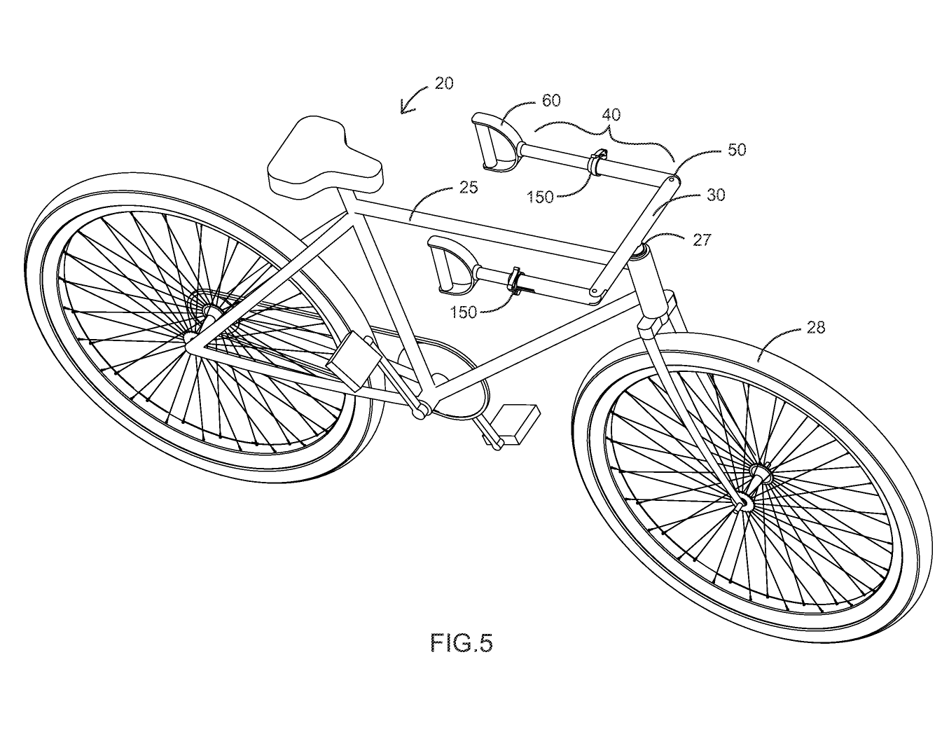

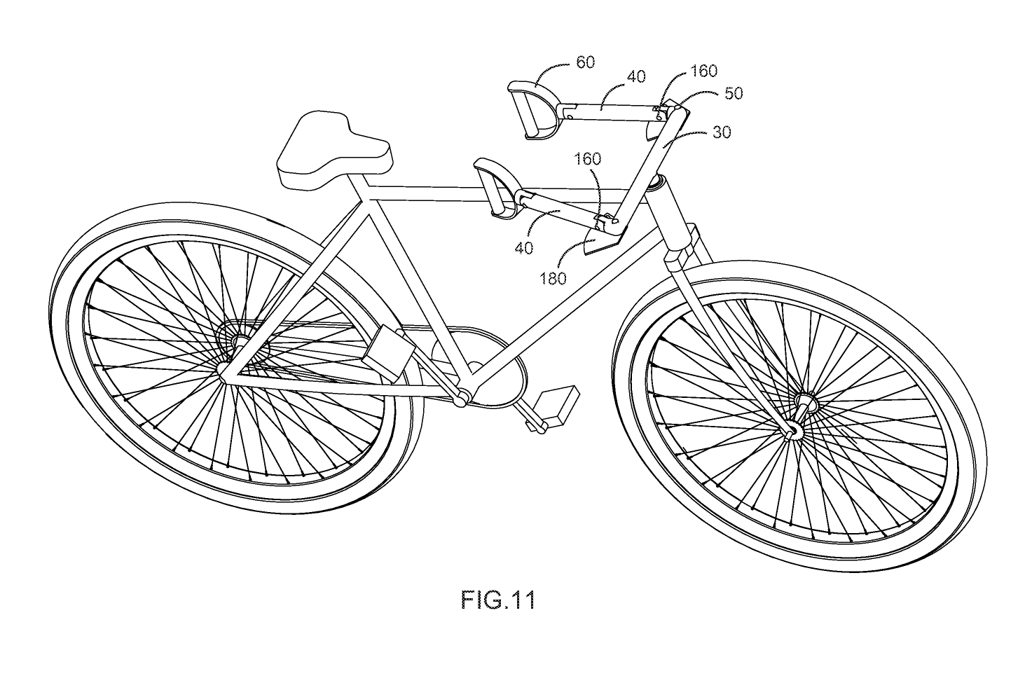

In one embodiment, each tie rod 40 includes a telescoping mechanism 150 (FIG. 5), such that the length of each tie rod 40 may be selectively adjusted and locked where desired. In another embodiment, each tie rod 40 further includes a generally horizontally-oriented forth pivot 160 (FIG. 8) proximate the forward end 48 thereof. Each forth pivot 160 may further include a drop stop 180 (FIG. 11) situated as to prevent the tie rod 40 from dropping below the substantially horizontal plane 170. As such, each tie rod 40 may be rotated upwardly from the horizontal plane 170 by substantially 90 degrees for comfort as desired by the rider, particularly tall riders.

In one embodiment, each tie rod 40 is made from an elastomeric or resilient material, such as urethane or the like (FIG. 17). Alternately, each tie rod 40 may include a shock-absorbing elastic material that dampens the response between the handles 60 and the handlebar 30, providing a smoother feel when steering the vehicle 20.

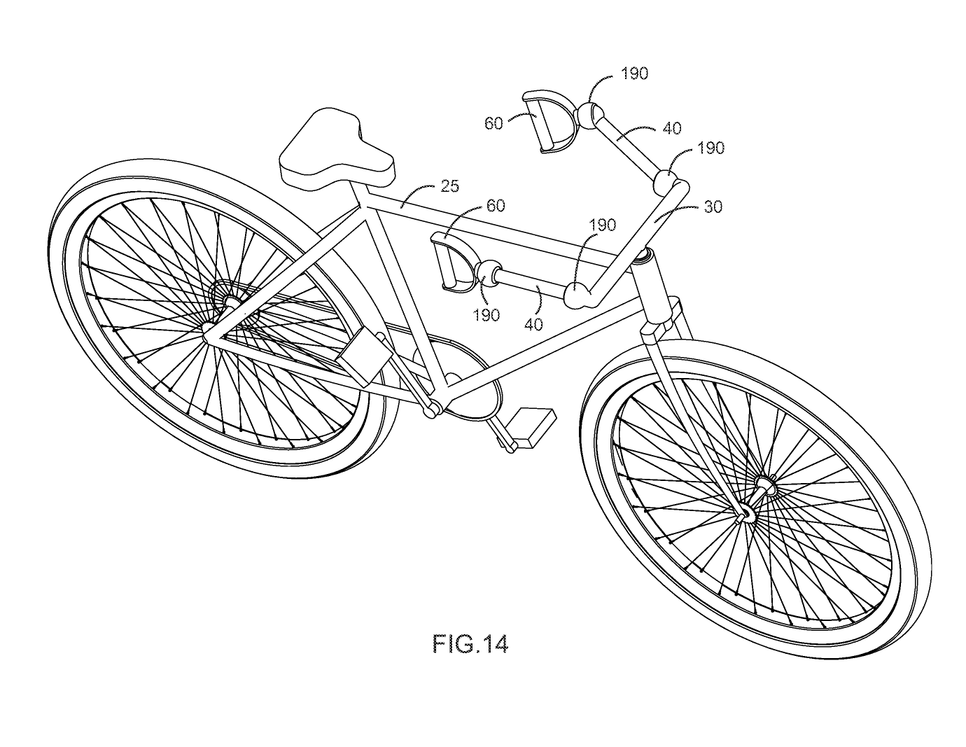

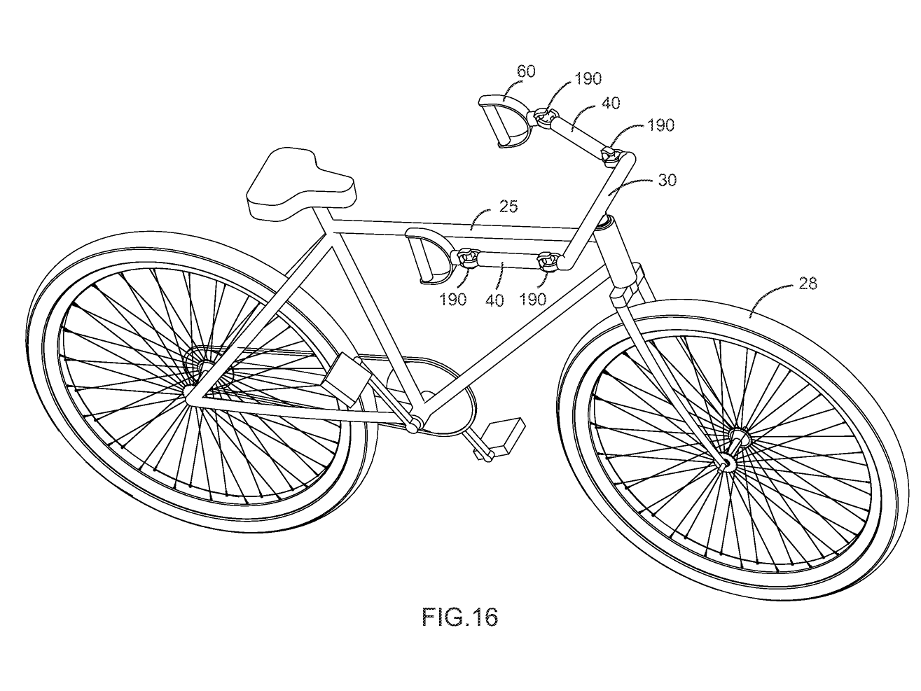

In one embodiment, the second pivot 50 and forth pivot 160 of each tie rod 40 may be replaced with a ball pivot 190 (FIGS. 14, 16), or equivalent, allowing substantially 180 degrees of horizontal pivoting of the tie rod 40 with the handlebar 30, and substantially 90 degrees of vertical upward pivoting of the tie rod 40 with the handlebar 30. For example, an equivalent structure to the ball pivot 190 may be a spring 230 (FIG. 15), which allows pivoting in more than one dimension. Further, the elastomeric tie rods 40, illustrated in FIG. 17, may also accomplish such a function.

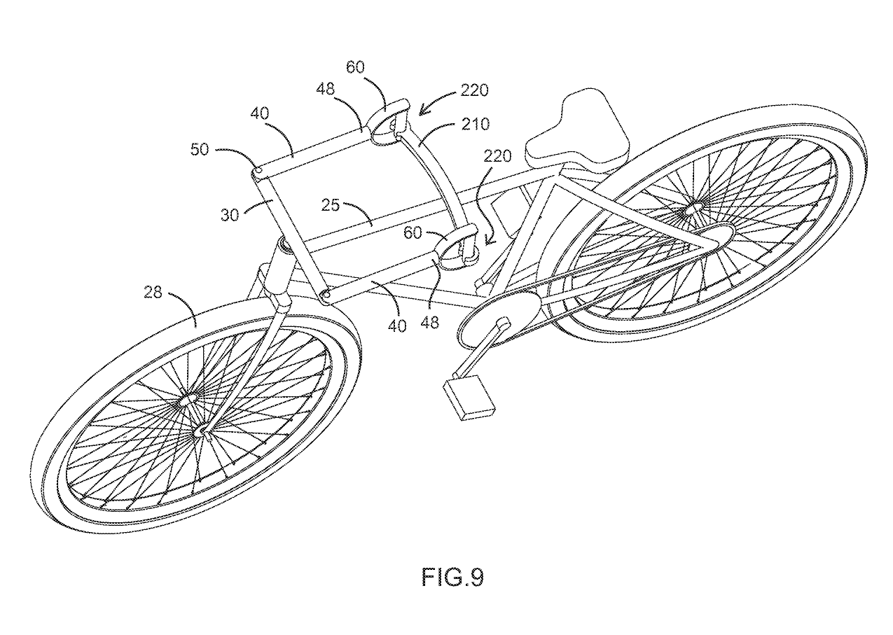

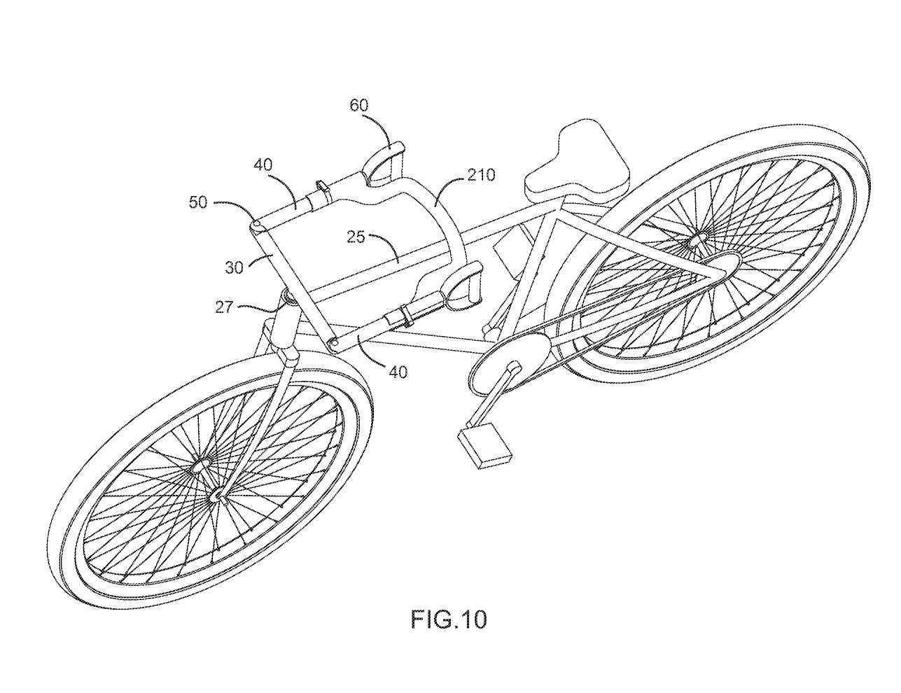

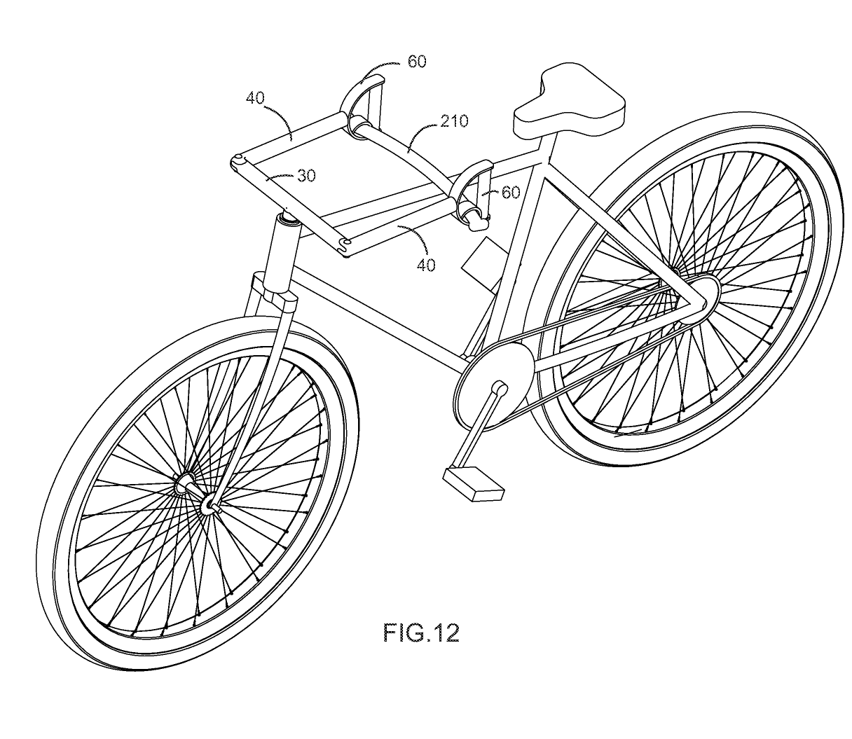

In one embodiment, each tie rod 40 may be mutually pivotally connected with a connecting rod 210 (FIG. 9) at a pair of fifth pivots 220 proximate the rearward ends 42 of the tie rods 40. Various vehicle controls (not shown) may be slidably fixed with such a connecting rod 210 for allowing convenient control of brakes, gear shifters, throttle, or similar controls at a position along the connecting rod 210 that is comfortable for the rider. An alternate embodiment of the connecting rod 210 is illustrated in FIG. 10, wherein the connecting rod 210 slides along the tie rods 40 as the vehicle 20 is steered from one direction to another. Two additional alternate embodiments of the connecting rods 210 are illustrated in FIGS. 12 and 13.

In use, pushing one of the tie rods 40 forward while pulling the other tie rod 40 backward results in turning of the handlebar 30 and the at least one front wheel 28. In an embodiment that includes the connecting rod 210, the rider may steer the at least one front wheel 28 by pushing or pulling opposing sides of the connecting rod 210. If the second pivots 50 are locked in place at a particular set angle, steering with the connecting rod 210 may be accomplished with just a side to side movement thereof.

While a particular form of the invention has been illustrated and described, it will be apparent that various modifications can be made without departing from the spirit and scope of the invention. Accordingly, it is not intended that the invention be limited, except as by the appended claims.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A handlebar arrangement for a vehicle of the type having at least one steerable front wheel pivotably fixed with a frame, the arrangement comprising:
a handlebar fixed with and adapted to turn the at least one front wheel, the handlebar having two opposing sides;
a pair of tie rods each pivotally attached at a forward end thereof proximate one of the sides of the handlebar at one of a pair of second pivots and being continuously free to rotate with respect to the handlebar independently of each other, each tie rod terminating at a rearward end thereof at a handle;
whereby pushing or pulling either of the tie rods results in turning of the at least one front wheel.

2. The handlebar arrangement of claim 1 wherein each handle is pivotally attached to the rearward end of one of the tie rods at one of a pair of third pivots.

3. The handlebar arrangement of claim 2 wherein each third pivot includes a biasing mechanism to bias the handle to return to a default pivotal position.

4. The handlebar arrangement of claim 1 wherein each second pivot is selectively moveable along the handlebar, whereby the torque required to turn the at least one front wheel is selectively adjustable.

5. The handlebar arrangement of claim 1 wherein the handle of each tie rod includes a rotational bearing, such that the handle is rotatable about an axis generally aligned with a longitudinal axis of the tie rod.

6. The handlebar arrangement of claim 5 wherein each handle includes a second biasing mechanism to bias the return of the handle to a default rotational position.

7. The handlebar arrangement of claim 1 wherein each tie rod includes a telescoping mechanism, whereby the length of each tie rod may be selectively adjusted.

8. The handlebar arrangement of claim 1 wherein the handlebar is substantially linear.

9. The handlebar arrangement of claim 1 wherein the handlebar is arched.

10. The handlebar arrangement of claim 1 wherein each tie rod further includes a forth pivot proximate the forward end thereof.

11. The handlebar arrangement of claim 10 wherein each forth pivot further includes a drop stop situated as to prevent the tie rod from dropping below a substantially horizontal plane.

12. The handlebar arrangement of claim 1 wherein each tie rod is mutually pivotally connected proximate at its rearward end with a connecting rod.

13. A handlebar arrangement for a vehicle of the type having at least one steerable front wheel pivotably fixed with a frame, the arrangement comprising:
a handlebar fixed with and adapted to turn the at least one front wheel, the handlebar having two opposing sides;
a pair of tie rods each pivotally attached at a forward end thereof proximate one of the sides of the handlebar at one of a pair of ball pivots, each tie rod terminating at a rearward end thereof at a handle, each ball pivot further including a drop stop to prevent the tie rod from dropping below a substantially horizontal plane;
whereby pushing or pulling either of the tie rods results in turning of the at least one front wheel.

14. The handlebar arrangement of claim 13 wherein each handle is pivotally attached to the rearward end of one of the tie rods at one of a pair of third pivots.

15. The handlebar arrangement of claim 14 wherein each pivot includes a biasing mechanism to bias the handle to return to a default pivotal position.

16. The handlebar arrangement of claim 13 wherein each ball pivot is selectively moveable along the handlebar, whereby the torque required to turn the at least one front wheel is selectively adjustable.

17. The handlebar arrangement of claim 13 wherein the handle of each tie rod includes a rotational bearing, such that the handle is rotatable about an axis generally aligned with a longitudinal axis of the tie rod.

18. The handlebar arrangement of claim 17 wherein each handle includes a second biasing mechanism to bias the return of the handle to a default rotational position.

19. The handlebar arrangement of claim 13 wherein each tie rod is mutually pivotally connected proximate at its rearward end with a connecting rod.

20. The handlebar arrangement of claim 13 wherein each tie rod is mutually slidably connected with a connecting rod.
